(19) United States
(12) Patent Application Publication
(10) Pub. No.: US 2017/0170479 A1
(43) Pub. Date: Jun. 15, 2017

(54) CATHODE MATERIALS CONTAINING OLIVINE STRUCTURED NANOCOMPOSITES

(71) Applicants: NANYANG TECHNOLOGICAL UNIVERSITY, Singapore (SG); THE MARITIME AND PORT AUTHORITY OF SINGAPORE, Singapore (SG)

(72) Inventors: Rachid YAZAMI, Singapore (SG); Somaye SAADAT, Singapore (SG)

(21) Appl. No.: 15/039,244

(22) PCT Filed: Feb. 26, 2015
(86) PCT No.: PCT/SG2015/000057

§ 371 Date: May 25, 2016

Related U.S. Application Data
(60) Provisional application No. 61/944,709, filed on Feb. 26, 2014.

(51) Int. Cl. H01M 4/58; H01M 10/0525; H01M 4/62; H01M 4/36; H01M 4/04

(52) U.S. Cl. CPC H01M 4/5825; H01M 4/364; H01M 4/0404; H01M 4/625; H01M 10/0525; H01M 2004/028

(57) ABSTRACT

The invention relates to cathode materials containing olivine structured nanocomposites for lithium batteries. In particular, the olivine structured nanocomposites include a mixture of lithium metal phosphates.

### CROSS-REFERENCE TO RELATED APPLICATION

This application claims the benefit of priority of U.S. Provisional Patent Application No. 61/944,709, filed Feb. 26, 2014, the contents of which being hereby incorporated by reference in its entirety for all purposes.

### TECHNICAL FIELD

The invention relates to cathode materials containing olivine structured nanocomposites for lithium batteries. In particular, the olivine structured nanocomposites include a mixture of lithium metal phosphates.

### BACKGROUND

Lithium iron phosphate (LiFePO₄ or LFP, for short) that belongs to the olivine group has recently emerged as a critical cathode material for a new generation of rechargeable batteries for use in computers, power tools, mobility products, consumer electronics, cellphones, large-scale power storage applications, and hybrid electric vehicles. Due to the stable and safe olivine structure of LFP materials afford, an increasing attention has been paid to lithium rechargeable batteries due to the continuous growing needs on energy conversion and storage for portable electronic devices, electric vehicles, hybrid electric vehicles, etc. This material has been known for its low cost, non-toxicity, and remarkable thermal stability for some time.

However, the olivine LFP shows some intrinsically disadvantages as a cathode material. Low electronic conductivity and slow lithium ion diffusion coefficient due to its 1D channel for Li⁺ insertion and extraction result in a poor rate capability. Many efforts have been made to overcome the above shortcomings and to improve the electrochemical performance. For example, carbon coating of the particles to overcome their low intrinsic electronic conductivity, reduction of the size of the particles, and the recent progress to free the material from impurities are few initiatives to improve the performance of LFP as cathode materials.

Whichever synthesis method is employed, the final product should fulfill the following three fundamental requirements in order to achieve an excellent electrochemical performance: (1) Li channels that are not blocked; (2) particles small enough to provide a high surface area and short diffusion paths for ionic transport and electron tunneling; (3) a complete, but thin coating with a conductive phase to ensure that the LiFePO₄ particles get electrons from all directions and that ions can penetrate through the coat without appreciable polarization.

### SUMMARY

Present invention is based on the inventors' surprising finding that a combination of two olivine structured cathode materials, each of them having a general formula LiMPO₄ where M is Fe, Mn, of identical or different compositions (Fe and Mn contents), prepared under different conditions and having different characteristics/morphology, shows improved energy storage performances as compared to the respective individual material. Here, the first material A may be a commercially available material and the second material B may be produced in-house using specific techniques. The mixture of A and B performs better than A and B used separately, which generates a synergetic effect between them. The weight fraction of B in the A and B mixture can range between 5% and 95%.

Thus, in accordance with a first aspect of the invention, there is provided a cathode material, comprising:

a first olivine structured nanocomposite having a formula of LiFePO₄ or LiFe_{y}Mn_{1-y}PO₄, wherein 0.2≦y≦0.4; and
a second olivine structured nanocomposite having a formula of LiFeₓMn₁₋ₓPO₄, wherein 0.2≦x≦0.4.

In a second aspect of the invention, a lithium rechargeable battery comprising a cathode material of the first aspect is disclosed.

According to a third aspect of the invention, there is provided a method for forming a cathode, comprising:

grinding to powder form a first olivine structured nanocomposite having a formula of LiFePO₄ or LiFe_{y}Mn_{1-y}PO₄, wherein 0.2≦y≦0.4;
grinding to powder form a second olivine structured nanocomposite having a formula of LiFeₓMn₁₋ₓPO₄, wherein 0.2≦x≦0.4;
dispersing the first olivine structured nanocomposite powder and the second olivine structured nanocomposite powder in N-methyl-2-pyrrolidone (NMP);
stirring the dispersion to form a slurry;
coating the slurry on a conductive foil; and
drying the coating to form the cathode.

A method for preparing an olivine structured nanocomposite having a formula of LiFeₓMn₁₋ₓPO₄, wherein 0.2≦x≦0.4, the method comprising:

providing in solid-state a mixture comprising a manganese precursor, an iron precursor, a lithium and phosphate precursor, and a carbon source;
mechanically working the mixture;
pelletizing the resultant mixture to form pellets; and
sintering the pellets in an inert gas environment to obtain the olivine structured nanocomposite.

### BRIEF DESCRIPTION OF THE DRAWINGS

In the drawings, like reference characters generally refer to the same parts throughout the different views. The drawings are not necessarily drawn to scale, emphasis instead generally being placed upon illustrating the principles of various embodiments. In the following description, various embodiments of the invention are described with reference to the following drawings.

FIG. 1 shows XRD patterns of the C—LiFePO₄ particles fabricated using hydrothermal method.

FIG. 2 shows EDS spectrum of C—LiFePO₄ particles fabricated using hydrothermal method.

FIG. 3 shows SEM of C—LiFePO₄ bars fabricated by hydrothermal method.

FIG. 4 shows XRD patterns of the C—LiMn_{0.7}Fe_{0.3}PO₄ particles fabricated using hydrothermal method.

FIG. 5 shows SEM of the C—LiMn_{0.7}Fe_{0.3}PO₄ particles fabricated using hydrothermal method.

FIG. 6 shows XRD patterns of the (A) commercial C—LiFePO₄, (B) commercial C—Li Fe_{0.33}Mn_{0.67}PO₄, (C) EDS of commercial C— Li Fe_{0.33}Mn_{0.67}PO₄ particles.

FIG. 7 shows (A-B) SEM, (C-D) TEM of commercial C—LiFePO₄, (E-F) SEM, (G-H) TEM of commercial C—LiFe_{0.33}Mn_{0.67}PO₄ particles.

FIG. 8 shows XRD patterns of the C—LiFe_{0.2}Mn_{0.8}PO₄ particles carbon coated using sucrose.

FIG. 9 shows (A-B) SEM, (C) TEM, (D) HRTEM of C—LiFe_{0.2}Mn_{0.8}PO₄ particle coated using 10 wt % sucrose.

FIG. 10 shows (A-B) SEM, (C) TEM, (D) HRTEM of C—LiFe_{0.2}Mn_{0.8}PO₄ particle coated using 20 wt % sucrose.

FIG. 11 shows (A-B) SEM, (C) TEM, (D) HRTEM of C—LiFe_{0.2}Mn_{0.8}PO₄ particle coated using 6 wt % sucrose and 4 wt % citric acid.

FIG. 12 shows XRD patterns of the LiFe_{0.3}Mn_{0.7}PO₄ particles.

FIG. 13 shows (A-B) SEM, (C) TEM, (D) HRTEM of C—LiFe_{0.3}Mn_{0.7}PO₄ coated using carbon black.

FIG. 14 shows (A-B) SEM of mixed commercial LiFePO₄ and in-house C—LiFe_{0.3}Mn_{0.7}PO₄(C-D) SEM of mixed commercial C—LiFe_{0.33}Mn_{0.67}PO₄ and in-house C—LiFe_{0.3}Mn_{0.7}PO₄.

FIG. 15 shows XRD patterns of C—LiFe_{0.3}Mn_{0.7}PO₄ particles fabricated by co-precipitation.

FIG. 16 shows (A-B) SEM of C—LiFe_{0.3}Mn_{0.7}PO₄ particles fabricated by co-precipitation.

FIG. 17 shows (A) charge/discharge cycling performance at a current of 0.1 C, (B) plot of the discharge and charge capacity vs. cycle number at various C rates of C—LiFe_{0.3}Mn_{0.7}PO₄ fabricated by hydrothermal between 2.7 and 4.4 V (vs Li/Li⁺).

FIG. 18 shows (A) charge/discharge voltage profiles at a current of 34 mA/g (0.2 C), (B) charge/discharge cycling performance at a current of 34 mA/g (0.2 C), (C) plot of the discharge and charge capacity vs. cycle number at various C rates of C—LiFe_{0.2}Mn_{0.8}PO₄ particles coated using sucrose between 2.7 and 4.4 V (vs Li/Li⁺).

FIG. 19 shows (A) charge/discharge voltage profiles at a current of 34 mA/g (0.2 C), (B) charge/discharge cycling performance at a current of 34 mA/g (0.2 C), (C) plot of the discharge and charge capacity vs. cycle number at various C rates of C—LiFe_{0.2}Mn_{0.8}PO₄ particles coated using sucrose and citric acid between 2.7 and 4.4 V (vs Li/Li⁺).

FIG. 20 shows (A) charge/discharge voltage profiles at 0.1 C rate, (B) charge/discharge cycling performance at 0.1 C rate, (C) charge/discharge cycling performance at 0.1 C rate, (D) plot of the discharge and charge capacity vs. cycle number at various C rates of C—LiFe_{0.3}Mn_{0.7}PO₄ particles coated using carbon black between 2.7 and 4.4 V (vs Li/Li⁺).

FIG. 21 shows (A) charge/discharge cycling performance at 0.1 C, (B) plot of the discharge and charge capacity vs. cycle number at various C rates of commercial C—LiFePO₄ between 2.7 and 4.4 V (vs Li/Li⁺), (C) charge/discharge cycling performance at 0.1 C, (D) plot of the discharge and charge capacity vs. cycle number at various C rates of commercial C—LiFe_{0.3}Mn_{0.7}PO₄ between 2.7 and 4.4 V (vs Li/Li⁺).

FIG. 22 shows (A) charge/discharge cycling performance at 0.1 C, (B) plot of the discharge and charge capacity vs. cycle number at various C rates of mixed commercial C—LiFePO₄ and in-house fabricated C—LiFe_{0.3}Mn_{0.7}PO₄ between 2.7 and 4.4 V (vs Li/Li⁺), (C) charge/discharge cycling performance at 0.1 C, (D) plot of the discharge and charge capacity vs. cycle number at various C rates of mixed commercial C—LiFe_{0.33}Mn_{0.67}PO₄ and in-house fabricated C—LiFe_{0.3}Mn_{0.7}PO₄ between 2.7 and 4.4 V (vs Li/Li⁺).

### DESCRIPTION

The following detailed description refers to the accompanying drawings that show, by way of illustration, specific details and embodiments in which the invention may be practised. These embodiments are described in sufficient detail to enable those skilled in the art to practise the invention. Other embodiments may be utilized and changes may be made without departing from the scope of the invention. The various embodiments are not necessarily mutually exclusive, as some embodiments can be combined with one or more other embodiments to form new embodiments.

According to a first aspect of the invention, a cathode material is herein disclosed. In present context, the cathode is a positive electrode for use in a lithium-ion secondary or rechargeable battery.

The cathode material includes a first olivine structured nanocomposite having a formula of LiFePO₄ or LiFe_{y}Mn_{1-y}PO₄, wherein 0.2≦y≦0.4.

In present context, an olivine structured nanocomposite refers to a nanocomposite that has an olivine crystal structure.

In present context, LiFePO₄ refers to lithium iron phosphate and may be abbreviated by LFP.

In present context, LiFe_{y}Mn_{1-y}PO₄ refers to lithium iron manganese phosphate and may be abbreviated by LFMP.

In various embodiments, the first olivine structured nanocomposite may consist of only LiFePO₄.

In alternative embodiments, the first olivine structured nanocomposite may consist of only LiFe_{y}Mn_{1-y}PO₄, wherein 0.2≦y≦0.4. For example, y may be 0.2, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, or 0.4.

In one embodiment, the first olivine structured nanocomposite may consist of LiFe_{0.33}Mn_{0.67}PO₄. In another embodiment, the first olivine structured nanocomposite may consist of LiFe_{0.2}Mn_{0.8}PO₄.

In yet further embodiments, the first olivine structured nanocomposite may include both LiFePO₄ and LiFe_{y}Mn_{1-y}PO₄.

The cathode material further includes a second olivine structured nanocomposite having a formula of LiFeₓMn₁₋ₓPO₄, wherein 0.2≦x≦0.4.

In present context, similar to the definition of LiFe_{y}Mn_{1-y}PO₄, LiFeₓMn₁₋ₓPO₄ refers to lithium iron manganese phosphate and may be abbreviated by LFMP.

In various embodiments, the second olivine structured nanocomposite may include LiFeₓMn₁₋ₓPO₄, wherein x is 0.2, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, or 0.4.

In one embodiment, the second olivine structured nanocomposite may include LiFe_{0.3}Mn_{0.7}PO₄.

LiFePO₄ may be synthesized by any known technique. For example, existing LiFePO₄ synthesis technique includes solid-state method, hydrothermal, sol-gel, and co-precipitation, just to name a few.

In general, in the solid-state method for synthesizing LiFePO₄, LiF, Li₂CO₃, LiOH.2H₂O and CH₃COOLi are used as the lithium source, FeC₂O₄.2H₂O, Fe(CH₃COO₂)₂ and FePO₄(H₂O)₂ are used as the iron source, NH₄H₂PO₄ and (NH₄)₂HPO₄ are used as the phosphorus source and details of the synthesis may be found in Y. Zhang, Q.-y. Huo, P.-p. Du, L.-z. Wang, A.-q. Zhang, Y.-h. Song, Y. Lv and G.-y. Li, Synthetic Metals, 2012, 162, 1315-1326; C. Lai, Q. Xu, H. Ge, G. Zhou and J. Xie, Solid State Ionics, 2008, 179, 1736-1739; Y. Z. Dong, Y. M. Zhao, Y. H. Chen, Z. F. He and Q. Kuang, Materials Chemistry and Physics, 2009, 115, 245-250; S. Luo, Z. Tang, J. Lu and Z. Zhang, Ceramics International, 2008, 34, 1349-1351, the contents of which are herein incorporated in their entirety by reference.

In general, in the hydrothermal method for synthesizing LiFePO₄, LiOH.H₂O, FeSO₄.7H₂O and H₃PO₄ (85 wt. % solution) may be used as the starting material, and the optimized molar ratio of Li:Fe:P in the starting material may be 3:1:1. Polyethylene glycol (PEG) is added during the hydrothermal reaction (S. Tajimi, Y. Ikeda, K. Uematsu, K. Toda and M. Sato, Solid State Ionics, 2004, 175, 287-290). Alternatively, LiFePO₄ may be prepared by rheological phase reaction using PEG as carbon source, and the starting materials may be Li₂CO₃, FeC₂O₄.2H₂O, NH₄H₂PO₄ and PEG. The precursor was heated at 500° C. for 12 h in Ar atmosphere to get the LiFePO₄/C powders (L. N. Wang, X. C. Zhan, Z. G. Zhang and K. L. Zhang, Journal of Alloys and Compounds, 2008, 456, 461-465). In yet another example, FeSO₄.7H₂O, (NH₄)₂HPO₄, LiC₆H₅O₇.4H₂O and phenanthroline are used as the starting materials at 300° C. by hydrothermal route (Z. Wang, S. Su, C. Yu, Y. Chen and D. Xia, Journal of Power Sources, 2008, 184, 633-636). The contents of references cited above are herein incorporated in their entirety by reference.

In general, in the co-precipitation method for synthesizing LiFePO₄, lithium and phosphate compounds in mixed precursor solutions are co-precipitated by controlling the pH values. The co-precipitated slurries are then filtered, washed, and dried under N₂ atmosphere. During that process, dried precursors may form amorphous LiFePO₄. Crystalline LiFePO₄ powders are obtained by carrying out the calcinations at 500 to 800° C. for 12 h under N₂ or argon flow. Depending on the precursors and other processing conditions, the particle sizes of the synthesized LiFePO₄ powders can range from 100 nm to several microns (O. Toprakci, H. A. K. Toprakci, L. Ji and X. Zhang, KONA Powder and Particle Journal, 2010, 28, 50-73; G. Arnold, J. Garche, R. Hemmer, S. Ströbele, C. Vogler and M. Wohlfahrt-Mehrens, Journal of Power Sources, 2003, 119-121, 247-251; J. C. Zheng, X. H. Li, Z. X. Wang, H. J. Guo and S. Y. Zhou, Journal of Power Sources, 2008, 184, 574-577). The contents of references cited above are herein incorporated in their entirety by reference.

The second olivine structured nanocomposite LiFeₓMn₁₋ₓPO₄ may be synthesized by any known technique for synthesizing LiFePO₄ as described above. For example, such synthesis technique includes the solid-state method, hydrothermal, sol-gel, and co-precipitation, just to name a few, but with the addition of a manganese precursor in the starting material. Details of the various synthesis techniques for LiFeₓMn₁₋ₓPO₄ will be described in the example section below.

According to another aspect of present disclosure, a method for preparing an olivine structured nanocomposite having a formula of LiFeₓMn₁₋ₓPO₄, wherein 0.2≦x≦0.4, is provided (i.e. the second olivine structured nanocomposite). The method includes providing in solid-state a mixture comprising a manganese precursor, an iron precursor, a lithium and phosphate precursor, and a carbon source. In other words, the manganese precursor, the iron precursor, and the lithium and phosphate precursor are reacted via a solid-state reaction. Preferably, the manganese precursor, the iron precursor, the lithium and phosphate precursor are mixed in stoichiometric ratio with the carbon source, although not necessarily so.

The manganese precursor may, for example, be MnCO₃ or MnC₂O₄.2H₂O.

The iron precursor may, for example, be Fe(C₂O₄)₂.2H₂O.

The lithium and phosphate precursor may, for example, be LiH₂PO₄, or Li₂CO₃ and NH₄H₂PO₄.

The carbon source may be selected from the group consisting of carbon black (acetylene black), sucrose, citric acid, and malconic acid.

The method further includes mechanically working the mixture. In various embodiments, mechanically working the mixture may include ball milling the mixture, such as for a period of 7 hours at 300 rpm.

The method further includes pelletizing the resultant mixture to form pellets and sintering the pellets in an inert gas environment to obtain the olivine structured nanocomposite. The inert gas environment may include argon and additionally hydrogen.

By forming the second olivine structured nanocomposite via the solid-state method described above, the nanocomposite particles obtained thereof can be in nanometre in size. This is shown in FIG. 13 whereby the particle size of the thus-formed nanocomposite is smaller and size distribution in this product is less narrow and falls in the range of 100 to 200 nm, with length less than 1 μm. Advantageously, decreasing the particle size leads to a decrease in solid-state transport length and an increase in surface reactivity and decreasing tension build up during cycling, which results on improved electrochemical performance.

In various embodiments, the second olivine structured nanocomposite may be present in 5% to 95% based on the total weight of the first olivine structured nanocomposite and the second olivine nanocomposite. For example, the second olivine structured nanocomposite may be present in 40% based on the total weight of the first olivine structured nanocomposite and the second olivine nanocomposite, although other weightage is also possible.

A challenge to the use of LFP and LFMP in batteries is the insulating behavior of the phosphate. This can be overcome to a certain extent by coating the particles with a conducting layer of carbon, for example. Thus, in preferred embodiments, at least one of the first olivine structured nanocomposite and the second olivine structured nanocomposite is coated with carbon, more preferably both the first and second olivine structured nanocomposites are coated with carbon.

It is known that LFP and LFMP nanocomposites exhibit different morphology and therefore different properties, behaviours and characteristics when prepared under different synthesis conditions and different synthesis routes.

However, present invention is based on the inventors' surprising finding that a combination of two olivine structured cathode materials, each of them having a general formula LiMPO₄ where M is Fe, Mn, of identical or different compositions (Fe and Mn contents), prepared under different conditions and having different characteristics/morphology, shows improved energy storage performances as compared to the respective individual material. In other words, instead of solely using one type of olivine structured cathode material that shows superior performance on its own, by combining it with another type of olivine structured cathode material whose performance may not be as good, the combination results in a better performance than each of the olivine structured cathode material itself.

To demonstrate this synergistic effect, a method for forming a cathode is herein disclosed.

The method includes grinding to powder form a first olivine structured nanocomposite having a formula of LiFePO₄ or LiFe_{y}Mn_{1-y}PO₄, wherein 0.2≦y≦0.4. The method further includes grinding to powder form a second olivine structured nanocomposite having a formula of LiFeₓMn₁₋ₓPO₄, wherein 0.2≦x≦0.4.

For convenience, the first olivine structured nanocomposite may be obtained from a commercial source while the second olivine structured nanocomposite may be prepared by any one of the known synthesis methods described herein.

After obtaining the powder form of the first and second olivine structured nanocomposites, the first olivine structured nanocomposite powder and the second olivine structured nanocomposite powder are dispersed in N-methyl-2-pyrrolidone (NMP) and stirred to form a slurry.

Next, the slurry is coated on a conductive foil such as an aluminium foil. For example, the slurry may be coated on an aluminium foil using doctor blade equipment.

After coating the slurry on the conductive foil, the coating is dried to form the cathode.

In various embodiments, in the dispersing step a carbon source such as, but is not limited to, carbon black, acetylene black, or Super-P®, may be added to the mixture of the first olivine structured nanocomposite powder and the second olivine structured nanocomposite powder.

In preferred embodiments, in the dispersing step polyvinylidene fluoride is also added to the mixture of the first olivine structured nanocomposite powder, the second olivine structured nanocomposite powder, and the carbon source.

The cathode disclosed herein or formed by the method disclosed herein is suitable for use in a lithium rechargeable battery due to the following advantages:
LFP and LFMP nanocomposites are environmental friendly
LFP and LFMP nanocomposites are stable against overcharge or discharge, and are compatible with most electrolyte systems
LFP and LFMP nanocomposites are safer than LiCoO₂ and LiMn₂O₄ for their stable structures under continuous charging and discharging situations
LFP and LFMP nanocomposites demonstrate superior high temperature and storage performance
LFP and LFMP nanocomposites demonstrate more than 1,000 cycle life

In order that the invention may be readily understood and put into practical effect, particular embodiments will now be described by way of the following non-limiting examples.

### EXAMPLES

Experimental Information for Cathode Fabrications

Materials

Hydrothermal Method

FeSO₄.7H₂O (Aldrich, >99%), MnSO₄.H₂O (Aldrich, >99%), Li₂SO₄.H₂O (Aldrich, 99.9%), LiOH (Aldrich, >98%), H₃PO₄ (Aldrich, purity >85%), Ascorbic acid (Aldrich, >99%), Sucrose (Aldrich, >99%).

Solid State Method

MnCO₃ or MnC₂O₄.2H₂O (Aldrich, >99%), Fe(C₂O₄).2H₂O (Aldrich, 99.9%), LiH₂PO₄ or Li₂CO₃ and NH₄H₂PO₄ (Aldrich, >99%) were used as olivine precursors. Carbon black (acetylene black), Sucrose (Aldrich, 99%), citric acid (Aldrich, 99%) and malconic acid (Aldrich, 99%) were used as carbon sources. Also, commercially available carbon coated LiFePO₄ and LiMn_{0.67}Fe_{0.33}PO₄ powders; products of Clariant were used as received.

Co-Precipitation Method

(NH₄)H₂PO₄ (Aldrich, >98%), CH₃COOLi.2H₂O (Aldrich, >99%), (CH₃COO)₂Mn.4H₂O (Aldrich, 98%), Fe(CH₃COO)₂ (Aldrich, 95%).

Synthesis of Lithium Iron Manganese Phosphate (LFMP)

Hydrothermal Synthesis

The LiFePO₄ was prepared by hydrothermal reaction in 50 ml containers. Specifically the starting materials were FeSO₄.7H₂O (98% Aldrich), MnSO₄.H₂O (98% Aldrich), H₃PO₄ (85 wt. % solution Aldrich), LiOH (98% Aldrich). The molar ratio of the Li:M(Fe, Mn):P was 3:1:1, and a typical concentration of FeSO₄ was 22 g·l⁻¹ of water. Sugar and/or I-ascorbic acid (99% Aldrich) were added as an in situ reducing agent to minimize the oxidation of ferrous to ferric, 1.3 g·l⁻¹ was used. The mixture was vigorously stirred for 1 min and transferred in a Teflon-lined stainless steel autoclave and heated at 190° C. for 7 h. The autoclave was then cooled to room temperature and the precipitated products were filtrated and finally dried at 100° C. for 10 h. The heat treatment was carried out in Ar—H₂ atmosphere at 700° C. (5° C./min) for 10 h to obtain the crystalline phase and to carbonize the reducing agent, thereby obtaining a carbon film that homogeneously covers the grains.

One-Step Solid State Synthesis and Carbon Coating

The C—LiMn_{0.7}Fe_{0.3}PO₄ and C—LiMn_{0.8}Fe_{0.2}PO₄ compound with an olivine structure were synthesized by a solid-state reaction between MnCO₃, Fe(C₂O₄).2H₂O, and LiH₂PO₄, which were mixed thoroughly in stoichiometric ratio with carbon source. Three types of carbon source were used; carbon black (acetylene black), sucrose and citric acid. The mixture was reground by high energy ball milling with 300 rpm speed for 7 hours. The ball to powder ratio was kept constant at 30 and a combination of large and small balls were used. The sintering was performed under Ar and Ar—H₂ atmosphere. The samples were pressed into pellets and sintered at 500 to 700° C. for 10 h.

Physical Mixing of Commercial C-LFP and C-LFMP and In-House C-LFMP Fabricated Using Solid State Method

After sintering of in-house LFMP products, the powders were grinded manually using mortar and pestle and mixed with commercial C-LFP and C-LFMP. The weight fraction of in-house/commercial nanocomposites in the mixture can range between 5% and 95%. In this example, results of in-house/commercial nanocomposite ratio of 40/60 is demonstrated. For optimum mixing, the powders were dispersed in ethanol or N-methyl-2-pyrrolidone (NMP) and stirred overnight. When ethanol was used, the powders were dried at 80° C. under vacuum condition. The mixed powders were grinded before slurry preparation.

Co-Precipitation Method

To fabricate LFMP powders using co-precipitation method, stoichiometric amounts of CH₃COOLi.2H₂O, (CH₃COO)₂Mn.4H₂O and Fe(CH₃COO)₂ (Aldrich, 95%) were added to 100 cc of absolute ethanol while stirring. The ratio of Fe:Mn precursors was maintained as 30:70. (NH₄)H₂PO₄ was added to 3-4 cc of water and dissolved using ultrasonication. The water solution was added to ethanol solution dropwise under stirring to start precipitation. The solution was stirred overnight. To apply carbon coating, 10 wt. % of sucrose was added to ethanol solution. Using a rotary evaporator the ethanol was evaporated and precipitates were dried in vacuum oven at 100° C. overnight. To crystallize the products, the fabricated powder was sintered under Ar—H₂ atmosphere at 700° C. for 10 h.

Sample Characterization

The sample morphology was examined using a field-emission scanning electron microscopy (FESEM; JEOL, JSM-7600F). The elemental compositions of the samples were characterized with energy-dispersive X-ray spectroscopy (EDX) which is attached to the SEM instrument. Crystallographic data of the specimen was collected using powder X-ray diffractometer (Bruker, Cu KR radiation with λ=1.5406 Å). The determination of the phase was done using the Match software. For TEM characterization, the samples were dispersed in ethanol. After ultrasonication for 2-10 mins, the solution was drop cast onto carbon coated 200 mesh Cu grids. TEM/HRTEM was obtained by using a JEOL 2010 system operating at 200 kV.

Cathode Preparation

80 wt % of active material prepared by different methods, 10 wt % carbon black (acetylene black) and 10 wt % polyvinylidene fluoride (PVDF) were mixed in a mortar. Then N-methyl-2-pyrrolidone (NMP) was added to prepare slurry, which was coated on a piece of Al foil using doctor blade equipment. The thickness of coated thin films was controlled at 50 μm. The coated foils were pressed using roll press and punched to 1.4 cm circles. After drying at 110° C. for 6 hours, the prepared cathode was pressed again using the roll press and the mass of the active material was accurately measured.

Property Measurement of Lithium Ion Battery

The coin cells were assembled inside an Ar-filled glove box with oxygen and moisture content less than 1.00 ppm. The prepared electrodes were used as the working electrode. The lithium foils were used as counter/reference electrodes and the electrolyte was a solution of 1 M LiPF₆ in ethylene carbonate (EC)/dimethyl carbonate (DMC) (1/1, w/w). For the electrochemical measurement coin battery cells were installed and galvanostically tested using a NEWARE battery tester between 2.7 and 4.4 V (vs. Li/Li⁺).

Result and Discussion of Cathode

Sample Characterization

Characterization of LFP and LFMP Obtained by Hydrothermal Synthesis

Solution methods for synthesizing LiFePO₄ and LiMnPO₄ provide intimate mixing of the starting ingredients at the atomic level, thus allowing finer particles of high purity to be produced by rapid homogeneous nucleation. Such methods are also faster and more economical than solid-state approaches. Therefore, many solution methods including co-precipitation, sol-gel processing, and hydrothermal synthesis, have been utilized to prepare olivines. Of these, hydrothermal synthesis offers the promise of simplicity, and scalability.

A key challenge in using aqueous solutions is to prevent the oxidation of ferrous to ferric. A reducing agent, such as hydrazine, has been used historically with mixed success in the formation of ferrous phosphates. Here, it is explored a few reducing agents such as ascorbic acid (vitamin C) and sugar for the hydrothermal formation of LiFePO₄ and LiFeₓMn₁₋ₓPO₄.

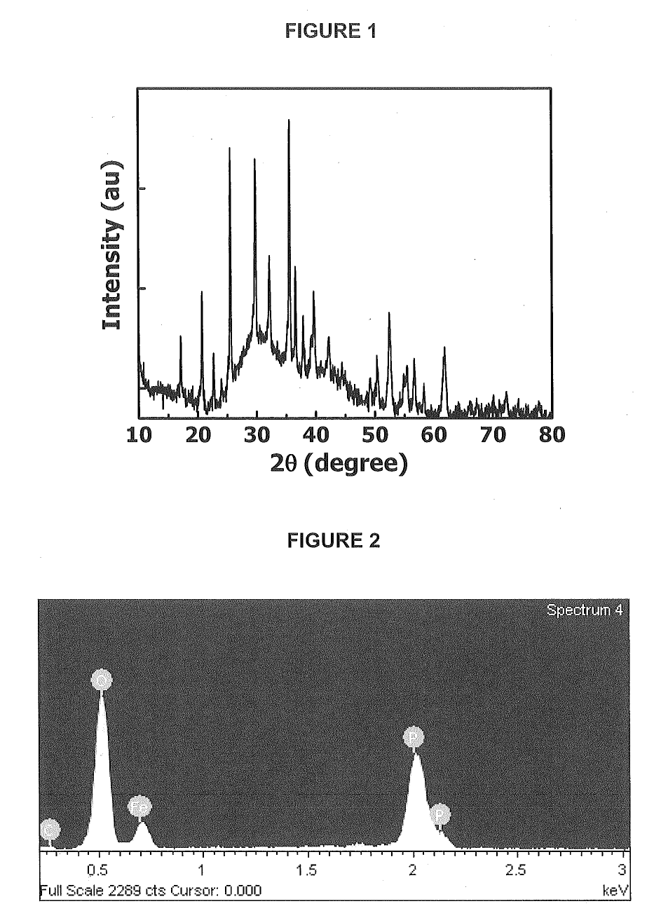

In the initial hydrothermal attempt, only iron precursor was used. This experiment was performed for comparison purposes and also for the simplification of the fabrication process. FIG. 1 shows the XRD patterns of LiFePO₄ prepared using the described hydrothermal method. All patterns were identified as orthorhombic structures with space groups of Pnma with no impurity phases. The EDS spectrum showed in FIG. 2 demonstrates that the fabricated powder has no impurity element.

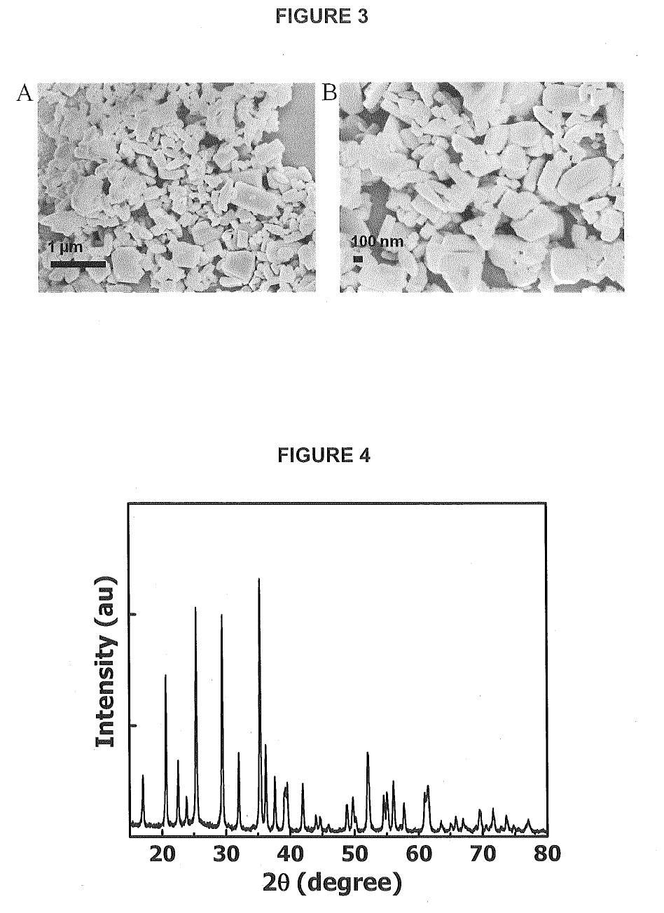

Preliminary results using ascorbic acid (vitamin C) showed the criticality of synthesis temperature and the presence of a reducing agent such as ascorbic acid. According to SEM observation shown in FIGS. 3A and 3B, the fabricated powder has bar shape morphology with a wide size distribution of 100 to 800 nm lengths. The morphology is heterogeneous and the bars with different thicknesses can be observed.

A challenge to the use of LiFePO₄ in batteries is the insulating behavior of the phosphate. This can be overcome by coating the particles with a conducting layer of carbon, for example. An attempt was therefore made to generate such a coating during the hydrothermal process. Ascorbic acid and sugar were added to the hydrothermal reactor, and a black product was formed. According to EDS, the sample has approximately 10 wt. % carbon.

As all the samples prepared in the presence of the surfactant were sintered at 700° C. (5.0° C. min⁻¹) in Ar—H₂, the presence of a carbonaceous phase, due to the decomposition of the ascorbic acid and sucrose after washing and filtering, has to be expected. Nevertheless, there is no evidence of such phase in the diffraction patterns (see FIG. 1), probably because it is present in a low content and/or it is amorphous, causing only a little increase of the background in the low-angle region. The heat treatment is performed under a reducing atmosphere as a precautionary measure in order to remove any iron oxide present in the powder. The olivine structure has one-dimensional tunnels. Any iron in the lithium tunnels will severely limit lithium insertion and removal. It is therefore essential to ensure complete ordering of the lithium and iron atoms and absence of any impurity.

In present disclosure, a mixed lithium metal phosphate is fabricated. Specifically, both manganese and iron precursors were used to fabricate olivine products. FIG. 4 shows the XRD patterns of the samples synthesized in the presence of the ascorbic acid and sucrose. The main diffraction peaks can be attributed to the orthorhombic olivine-type phase. Compared to the pure LiFePO₄ XRD patterns, the peaks are the same and have only slightly shifted.

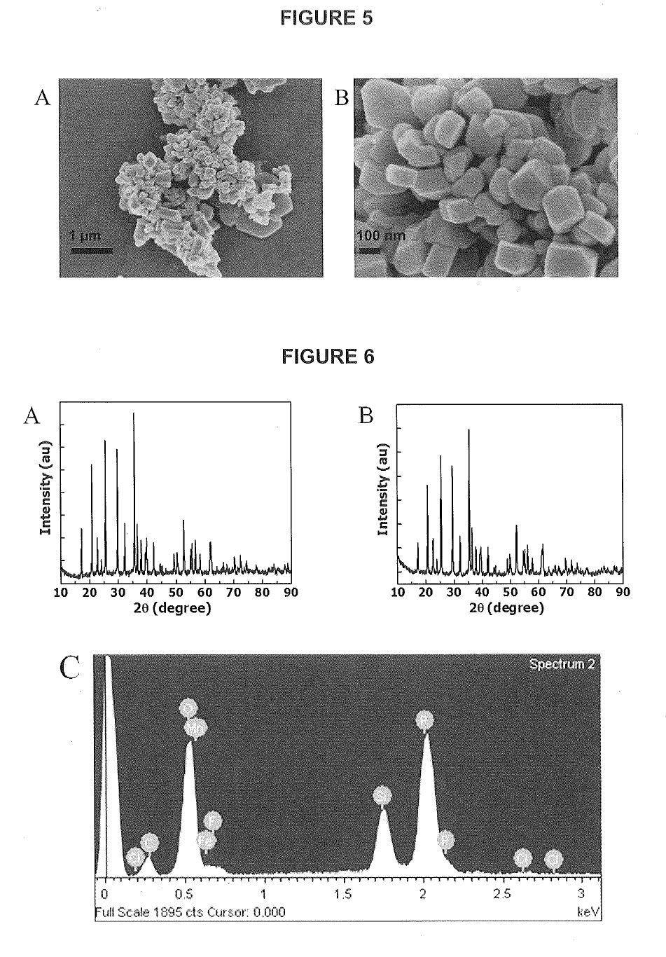

The SEM microphotographs, reported in FIG. 5, demonstrate bar/rod shaped morphology with rectangular intersection, similar to what was observed in LiFePO₄ in FIG. 3. However, the particle size is smaller and size distribution in this product is less narrow and falls in the range of 100 to 200 nm, with length less than 1 μm.

Characterization of Commercial Products

XRD examination of commercial powders (obtained from Clariant) is shown in FIGS. 6A and 6B, which demonstrates olivine phase with an orthorhombic structure (space group Pnma). To accurately calculate the amount of Fe/Mn ratio in the fabricated LiFeₓMn₁₋ₓPO₄ (LFMP) powder, energy-dispersive X-ray spectroscopy (EDX) were used. The EDS of the LFMP samples is shown in FIG. 6C. Peaks of Fe, Mn, O, C and P can be observed in the EDS spectrum and exposes average Fe:Mn ratio of 70:30. However, based on the company's reported description the olivine powder has LiFe_{0.33}Mn_{0.67}PO₄ composition.

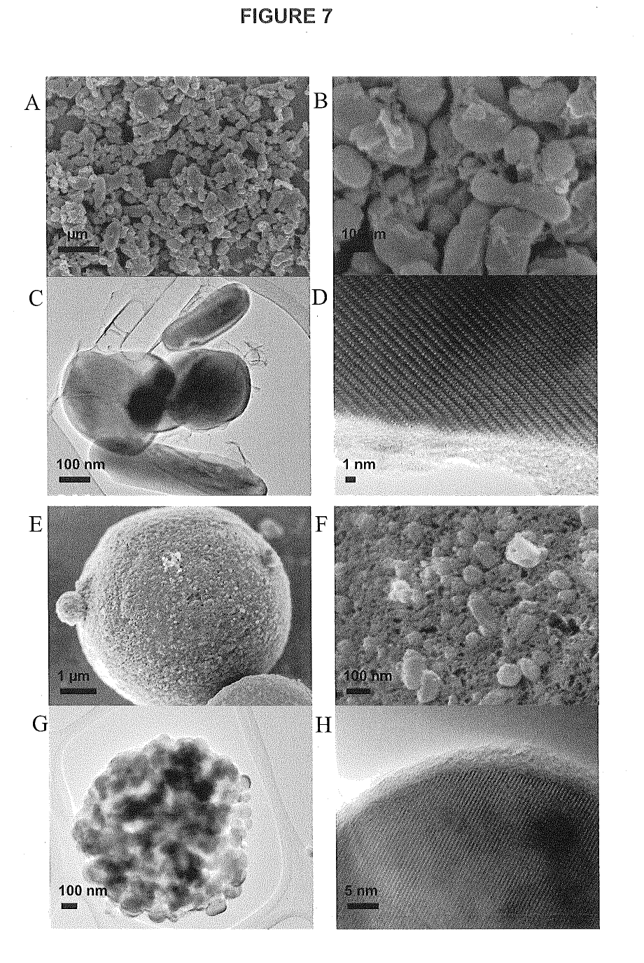

The morphology of commercial C-LFP particles is shown in FIGS. 7A and 7B. It can be seen that the powder is made of bars and sphere particles. The particles have a diameter of 100 to 300 nm, while the bars have a length of approximately 200 to 600 nm. The TEM presents a better understanding of the shape and size of the fabricated particles (see FIG. 7C). In this TEM image both sphere and bar particles can be observed. The HRTEM image (see FIG. 7D) shows that the particles are single crystals with high crystallinity. A uniform layer of carbon coating with 3 to 6 nm thickness covers the LFP particles.

The microstructure of commercial C-LFMP powders is shown in FIGS. 7E and 7F. It can be observed that the powder is composed of 5 to 10 μm granules. Each granule is composed of numerous fine round particles in the range of 20 to 150 nm. In the TEM image (see FIG. 7G) the round granule made up of numerous fine particles can be observed clearly. Its noteworthy that according to HRTEM (see FIG. 7H) each fine LFMP particle is a single crystal coated with a uniform thin layer of carbon coating with thickness of approximately 5 to 8 nm.

Characterization of Samples Obtained by One-Step Ball Milling

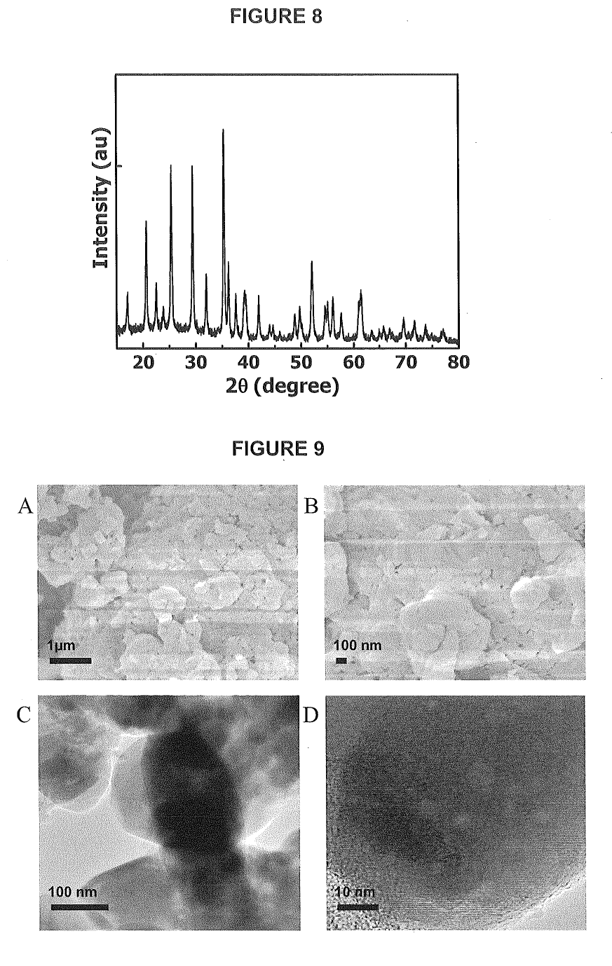

It is widely known and accepted that carbon coating is critical in olivine cathodes and a thin, uniform carbon coating with good contact with active materials is essential for achieving good electrochemical properties. In order to achieve superior battery performance three types of carbon coating were tested; carbon black (acetylene black), sucrose, combination of sucrose and citric acid. C-LFMP using 10 wt % sucrose was fabricated. The XRD analysis exposes formation of olivine compounds with an orthorhombic structure (space group Pnma) (see FIG. 8).

The morphology of C-LFMP particles is shown in FIGS. 9A and 9B. It can be seen that the powder is made of large agglomerates. It is difficult to measure the particle size using SEM, but it can generally be reported that the particles have a large particles size distribution and lay in a size range of 100 to 500 nm. The TEM presents a better understanding of the shape and size of the fabricated particles (see FIG. 9C). In this TEM image particles with 200 to 500 nm can be seen. The HRTEM photo (see FIG. 9D) shows that the particles are single crystals with high crystallinity. A uniform layer of carbon coating with ˜3 nm thickness covers the LFMP particles.

The amount of carbon source used is another important factor. It is possible that by increasing the carbon contents of the electrode a more uniform and complete coating is achieved and the conductivity of the cathode is improved. To evaluate this parameter another set of powders was fabricated using the same fabrication conditions and adding 20 wt % sucrose to the precursor chemicals.

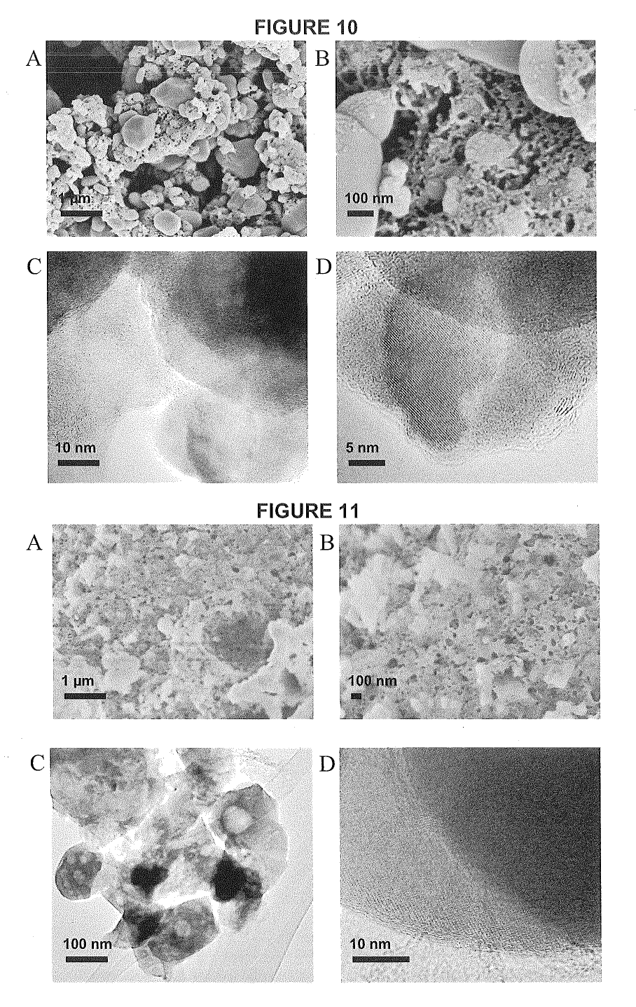

The microstructure of the fabricated powders is shown in FIGS. 10A and 10B. It can be observed that the amount of the carbon content largely influences the particle size. The size distribution is wider than before and particles with the size range of 50 nm to 1 μm can be observed. The smaller particles usually have round shapes, while the larger particles have facets. Additionally, some very small particles with 10 nm diameters can be observed randomly covering the LFMP particles. According to EDX and TEM examination, these particles are the excessive carbon which failed to form a coating on the particles. In the TEM photos (see FIGS. 10C and 10D) a combination of small and large particles with excessive carbon coating can be seen. The particles (see FIG. 10D) are single crystal with approximately 20 nm diameters and are coated with a heterogeneous 1 to 10 nm carbon coating. Based on this observation, it can be concluded that increasing sucrose content does not improve carbon coating and increases impurity and particle size variation.

In the next attempt, the amount of carbon source was decreased to 10 wt % and a combination of sucrose (6 wt %) and citric acid (4 wt %) was applied. The purpose of using citric acid is to increase the surface area of the active material by forming mesopores. The formation of these mesopores is due to the decomposition of citric acid during the sintering process. The formation of mesoporous agglomerates was observed in the SEM examination shown in FIGS. 11A and 11B. According to TEM and HRTEM (see FIGS. 11C and 11D) the mesoporous sample also has a mesoporous texture and the particles with the size range of 100 to 200 nm is surrounded uniformly by a 3 nm carbon layer. The particles are single crystal and are well crystallized.

To study the influence of addition of carbon black as carbon source during ball milling, the powders were fabricated using the same precursor and ball milling conditions. However, in this set of experiment the precursors were mixed in a respective ratio to fabricate C—LiFe_{0.3}Mn_{0.7}PO₄. The samples were fabricated in the presence of 10 wt. % carbon black.

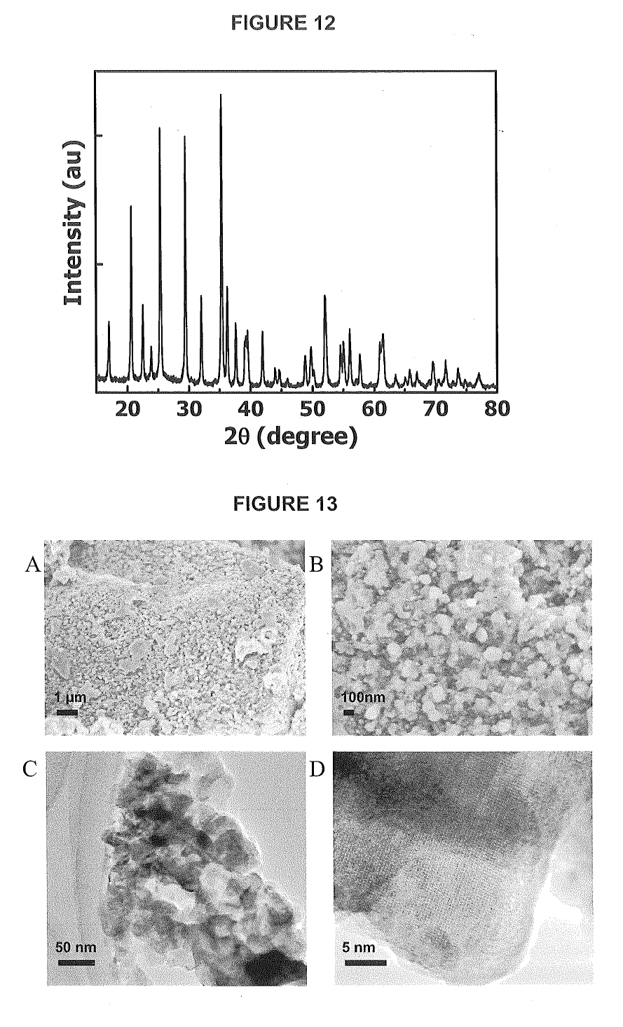

XRD examination shown in FIG. 12 demonstrates formation of olivine compounds with an orthorhombic structure (space group Pnma). The morphology of the samples can be observed in FIG. 13. The powder fabricated with carbon black is agglomerated (see FIGS. 13A and 13B). The particles mostly have round shapes with a broad size range of ˜50 to 150 nm diameters. The agglomeration is not severe and the particles can be distinguished apart. Based on the TEM examination the powder agglomerates are composed of several nano particles with porosity in between (see FIG. 13C). Each particle is highly crystalline with a uniform layer of 3 to 6 nm thickness carbon coating covering it completely and uniformly (see FIG. 13D).

The nanosized particles reduce the solid-state diffusion path, thus expediting the lithium-ion transport. However, to achieve high specific capacity, especially at high current density high porosity to enable penetration of electrolyte into the structure and reduction in the diffusion distance are required, Additionally, a uniform carbon coating is required on the particle surface to enhance electronic conductivity.

Characterization of Mixed Commercial and In-House Fabricated Olivine

C—LiFe_{0.3}Mn_{0.7}PO₄ powders fabricated using solid state process was discussed in the previous section. It is herein evaluated whether a mixture of A and B performs better than A and B used separately. It is confirmed that mixing of A and B in present case generates a synergetic effect between the components. The procedure is to mix C—LiFe_{0.3}Mn_{0.7}PO₄ powder fabricated in laboratory using solid state with industrial grade C—LiFePO₄/C—LiFe_{0.33}Mn_{0.67}PO₄ powder. This was performed with the aim to elevate the electrochemical performance.

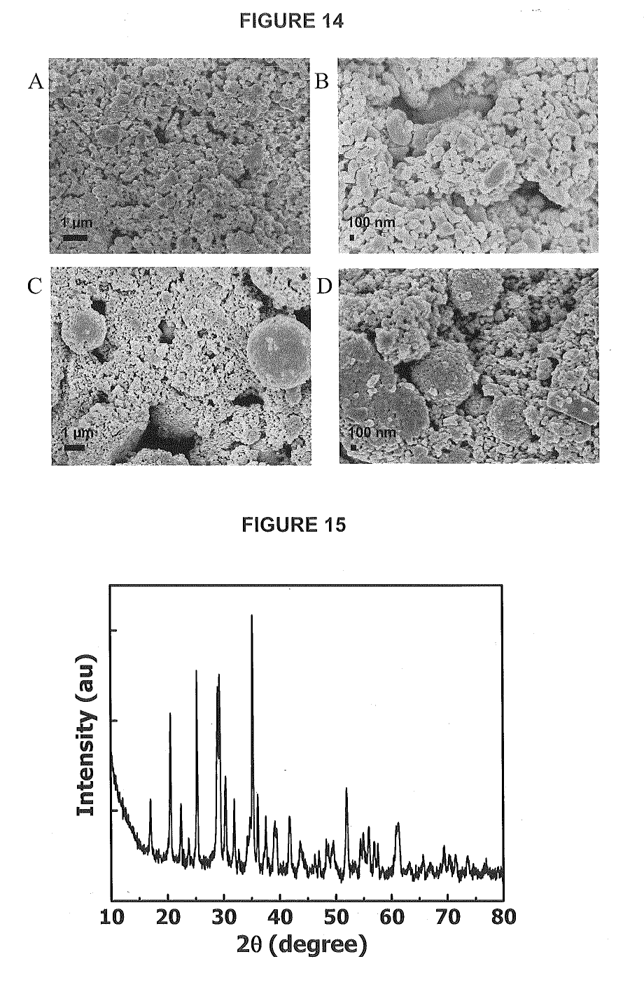

Two sets of samples were prepared. The first set was fabricated by mixing in-house fabricated C—LiFe_{0.3}Mn_{0.7}PO₄ with commercial C—LiFePO₄ and the second set by mixing it with commercial C—LiFe_{0.33}Mn_{0.67}PO₄. As can be seen in SEM images shown in FIG. 14 both constituents can be clearly seen and recognized in both set of samples. It is important to emphasize that complete mixing of the two components is essential. Therefore wet mixing by dispersing in ethanol or NMP and stirring until the mixture is uniform is of utmost importance.

Characterization of LFMP Obtained by Co-Precipitation

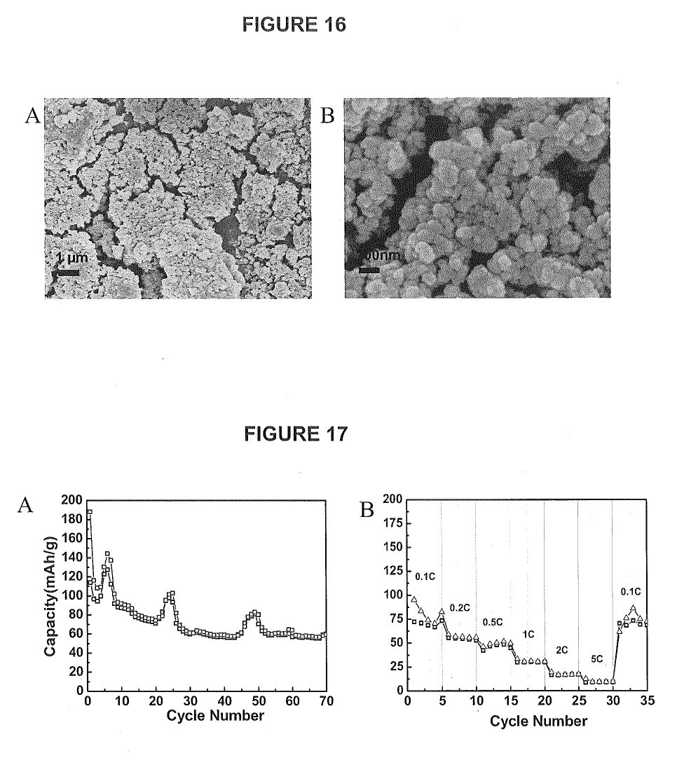

The XRD pattern of LFMP powders fabricated by simple co-precipitation process is shown in FIG. 15. The spectrum displays olivine phase with an orthorhombic structure (space group Pnma). The morphology of the sample is shown in FIGS. 16A and 16B. The SEM image (see FIG. 16A) indicates formation of small and homogenous agglomerated particles in micrometer range. Each micrometer agglomerate is composed of numerous particles in the size range of 10 to 80 nm.

The simplicity of the co-precipitation process, the purity of the products and the nanometer particle size makes this process an attractive method of fabrication. Additionally, the possibility of its application in large quantity and its use in industrial application should not be ignored.

The Electrochemical Properties of Olivine Electrodes

Electrochemical Performance of Samples Obtained by Hydrothermal Method

As explained in the characterization section, carbon coated LFMP was fabricated by hydrothermal method. FIG. 17A illustrates charge/discharge cycling plot of C—LiFe_{0.3}Mn_{0.7}PO₄, tested at (0.1 C) between 2.7 to 4.4 V (vs Li/Li⁺). The electrode delivers an initial charge capacity of 188 mA h/g and a subsequent discharge capacity of 114 mA h/g, resulting in an initial Coulombic efficiency of 60%. In the second cycle, the charge capacity decreases to 117 mA h/g with a corresponding discharge capacity of 97 mA h/g, improving the Coulombic efficiency to 83%. In the subsequent cycles, the Coulombic efficiency improves but the capacity decays to reach charge capacity of 60 mA h/g and subsequent discharge capacity of 59 mA h/g at the 70^{th} cycle, leading to 98% Coulombic efficiency (see FIG. 17A). The rate capability of the C-LFMP electrode, coated with sucrose was also examined. The electrode was examined at current densities from 0.1 to 5 C (see FIG. 17B). The 1^{st}-cycle charge capacities are 95 mAh/g, 57, 47, 33, 20 and 13 mAh/g at 0.1 C, 0.2 C, 0.5, 1, 2 C and 5 C, respectively. However, when the charge/discharge rate is decreased to 0.1 C, the discharge capacity can recover back to 61 mA h/g and continues to improve in the following cycles. The electrochemical properties including delivered capacity, cyclability and rate capability of the electrode fabricated by hydrothermal is not satisfactory. It is possible that by further optimization of fabrication process, finer and more dispersed crystalline particles with improved carbon coating can be fabricated, which can result in elevated electrochemical properties of olivine cathode.

Electrochemical Performance of Samples Obtained by One-Step Ball Milling

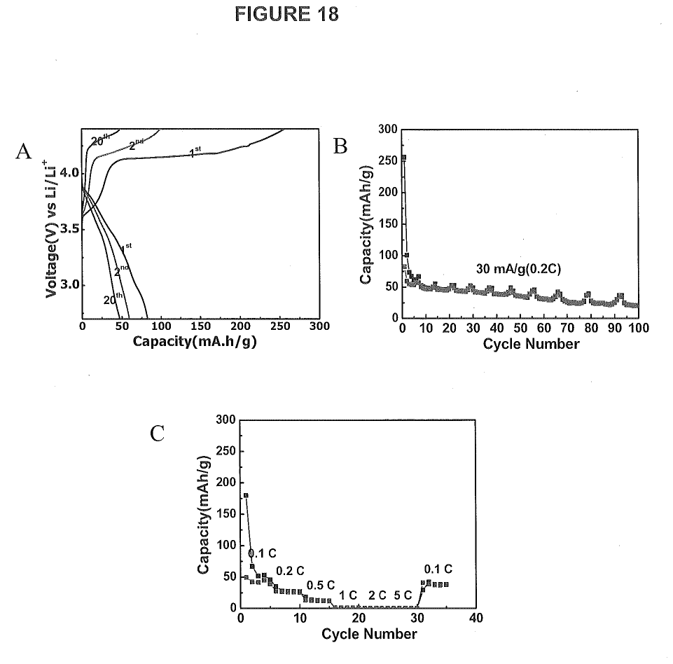

FIG. 18A illustrates the charge/discharge voltage profiles of C—LiFe_{0.2}Mn_{0.8}PO₄ particles coated using 10 wt % sucrose tested at 34 mA/g (0.2 C) between 2.7 to 4.4 V (vs Li/Li⁺). The initial cycle results in a charge capacity of 256 mA h/g and a subsequent discharge capacity of 82 mA h/g, this gives a very low initial Coulombic efficiency of 32%. In the second cycle, the charge capacity decreases to 100 mA h/g with a corresponding discharge capacity of 59 mA h/g, leading to a higher Columbic efficiency of 58%. The Columbic efficiency continues to improve in the following cycles, increasing to almost 100% after 100 cycles. However, based on the charge/discharge cycling results shown in FIG. 18B, the sample depicts poor cycling stability, decaying to charge capacity of 20 mA h/g at the 100^{th} cycle. The rate capability of the C-LFMP electrode coated with sucrose is not acceptable. The electrode was examined at current densities from 17 mA/g (0.1 C) to 85.5 mA/g (5 C) (see FIG. 18C). The 1^{st}-cycle charge capacities are 180 mA h/g, 35 mAh/g, and 18 mAh/g at 0.1 C, 0.2 C, and 0.5 C, respectively. At higher current densities, the capacity is dropped to lower than 10 mAh/g. However, when the charge/discharge rate is decreased to 0.1 C, it is found that the discharge capacity can recover back to 40 mAh/g with good coulombic efficiency.

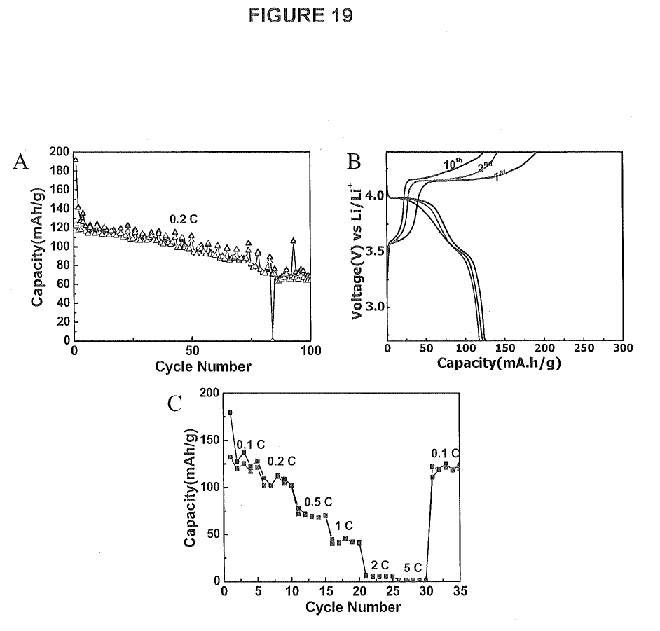

As explained in the previous section, another set of samples was fabricated using a combination of sucrose and citric acid as the carbon source. FIG. 19A illustrates the charge/discharge voltage profiles of C—LiFe_{0.2}Mn_{0.8}PO₄ electrode coated with 6 wt % sucrose and 4 wt % citric acid, tested at 34 mA/g (0.2 C) between 2.7 and 4.4 V (vs Li/Li⁺). It can be seen that the 2^{nd} cycle charge capacity of this sample is higher than the sample coated with sucrose. It delivers an initial charge capacity of 191 mA h/g and a subsequent discharge capacity of 124 mA h/g, resulting in an initial Coulombic efficiency of 64%. In the second cycle, the charge capacity decreases to 141 mA h/g with a corresponding discharge capacity of 117 mA h/g, improving the Columbic efficiency to 83%. In the subsequent cycles, the Columbic efficiency improves but the capacity decays to reach charge capacity of 70 mA h/g and subsequent discharge capacity of 64 mA h/g at the 100th cycle, leading to 93% Coulombic efficiency (see FIG. 19B).

The rate capability of the C-LFMP electrode coated with sucrose-citric acid was also examined. Similar to other two cathodes, the electrode was examined at current densities from 17 mA/g (0.1 C) to 85.5 mA/g (5 C) (see FIG. 19C). The 1^{st}-cycle charge capacities are 180 mAh/g, 110 mAh/g, 78 mAh/g, 44 mAh/g at 0.1 C, 0.2 C, 0.5 C and 1 C, respectively. At higher current densities, the capacity is dropped to lower than 10 mAh/g. However, when the charge/discharge rate is decreased to 0.1 C, the discharge capacity can recover back to 110 mAh/g. This result can be considered promising. Especially since the stability is acceptable for about 50 cycles and fades quickly after about 50 cycles. It is probable that by optimizing the sucrose/citric acid ratio and successfully increasing the total carbon content, the stability would improve.

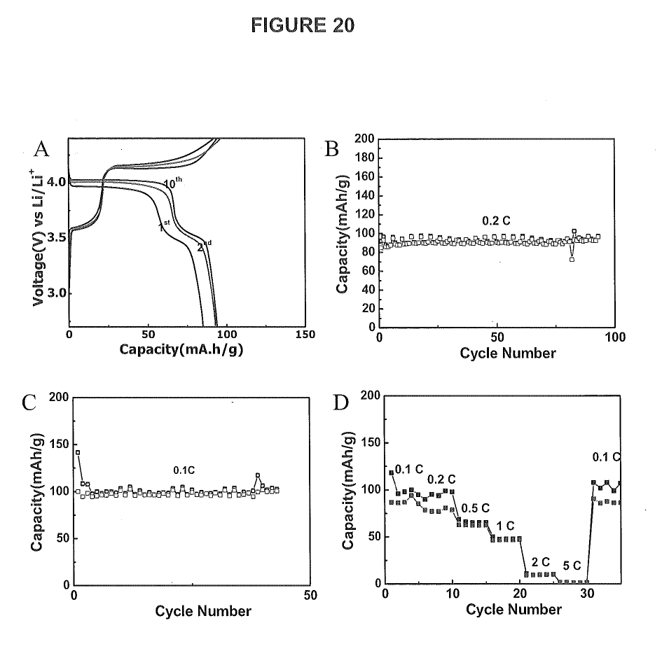

FIG. 20A illustrates the charge/discharge voltage profiles of C—LiFe_{0.3}Mn_{0.7}PO₄ electrode coated using carbon black and tested at 34 mA/g (0.2 C) between 2.7 and 4.4 V (vs Li/Li⁺). The charge/discharge plateaus at 4.1 V is related to the Mn²⁺/Mn³⁺ redox couple, and plateaus at 3.6 V is related to the Fe²⁺/Fe³⁺ redox couple. The first cycle gives a charge capacity of 92 mAh/g and a subsequent discharge capacity of 84 mAh/g, this results gives an initial Coulombic efficiency of 92%. In the second cycle, the charge capacity reaches 96.7 mAh/g with a corresponding discharge capacity of 92 mAh/g, leading to a high Columbic efficiency of 95%. Based on the charge/discharge cycling results shown in FIG. 20B, the sample depicts good cycling stability, delivering a discharge and charge capacity of 96 and 97 mAh/g, respectively, with Coulombic efficiency of 99% during the 93^{rd} cycle. At 17 mA/g (0.1 C) the capacity is slightly higher with an initial charge capacity of 141 mAh/g and discharge capacity of 100 mAh/g, which leads to 70.5% Coulombic efficiency (see FIG. 20C). In the second cycle capacity reduces to 108 mAh/g, with 87% Coulombic efficiency. The extra capacity in the initial cycle may be assigned to the solid electrolyte formation (SEI) and electrolyte decomposition. The electrode exposes good cycling stability and the Coulombic efficiency is gradually increased to reach 98% in the 43^{rd} cycle.

The rate capability of the C-LFMP electrode was further examined at current densities from 17 mA/g (0.1 C) to 85.5 mA/g (5 C) (see FIG. 20D). The 1^{st}-cycle charge capacities are 118 mAh/g, 90 mAh/g, 69 mAh/g, 50 mAh/g, 12 mAh/g and 2 mAh/g at 0.1 C, 0.2 C, 0.5 C, 1 C, 2 C and 5 C rates, respectively. The performance of C-LFMP electrode at each rate is stable, but capacity drop with increase in rate, especially at higher current densities is high. This demonstrates the poor Li storage properties of C-LFMP electrode at high cycling rates. When decreasing the charge/discharge rate to 0.1 C, it is found that the discharge capacity can recover back to 107 mAh/g, but the coulombic efficiency is low.

Electrochemical Performance of Commercial Olivine Powders

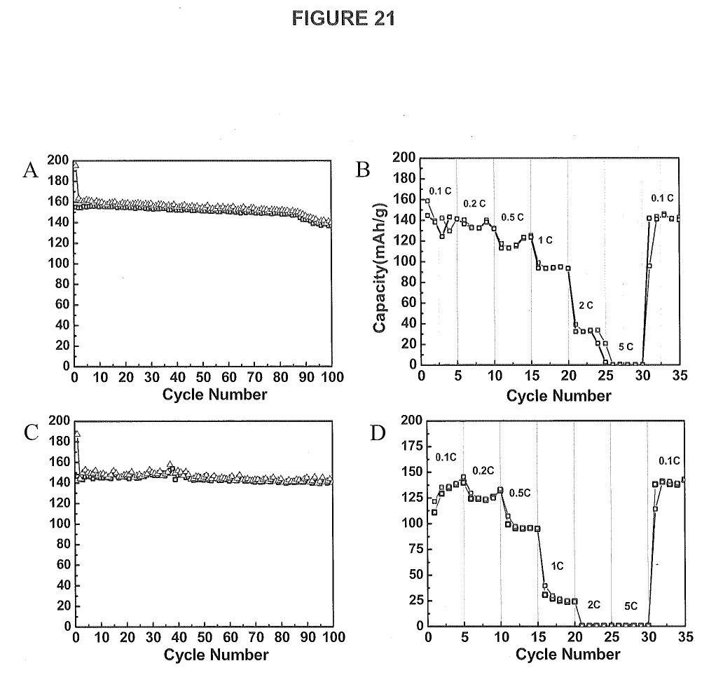

FIG. 21A illustrates the charge/discharge cycling of pure commercial C—LiFePO₄ at 0.1 C. The first cycle gives a charge capacity of 159 mAh/g and a subsequent discharge capacity of 155 mAh/g, these results gives a high initial Coulombic efficiency of 97%. In the second cycle, the charge capacity reaches to 160 mAh/g with a corresponding discharge capacity of 156 mAh/g, leading to a high Coulombic efficiency of 97.5%. It can be observed that the sample depicts very good cycling stability until about 80 cycles, thereafter some gradual capacity drop can be observed, resulting in a discharge and charge capacity of 139 and 137 mAh/g, respectively, with Coulombic efficiency of 98.5% during the 100^{th} cycle. In comparison to C-LFP, commercial C-LFMP demonstrates a lower delivered capacity (see FIG. 21C). As can be observed the olivine cathode demonstrates an initial charge capacity of 187 mAh/g and discharge capacity of 146 mAh/g, which leads to 78% Coulombic efficiency. In the second cycle capacity reduces to 144 mAh/g, with 143 mAh/g discharge capacity. The extra capacity in the initial cycle may be assigned to the solid electrolyte formation (SEI) and electrolyte decomposition. The electrode exposes good cycling stability, delivering charge capacity of 140 mAh/g and 99% Coulombic efficiency in the 100th cycle. By comparing the electrochemical properties of C-LFP and C-LFMP cathodes it can be concluded that although C-LFP electrode initially delivers a higher charge capacity than C-LFMP electrode, the C-LFMP exposes better cycling stability, delivering almost the same charge capacity as the C-LFP electrode after 100 cycles.

The rate capability of pure commercial C—LiFePO₄ and C—LiFe_{0.33}Mn_{0.67}PO₄ electrode was also examined at current densities from 0.1 to 0.5 C (see FIGS. 21B and 21D). The 1^{st}-cycle charge capacities of LFP are 159 mAh/g, 140 mAh/g, 117 mAh/g, 99 mAh/g, and 39 mAh/g, at 0.1 C, 0.2 C, 0.5 C, 1 C and 2 C, respectively. At 5 C rates, the capacity drops a lot, delivering almost no capacity. It can be seen that the performance of C-LFP electrode at each rate is stable, but capacity drop with increase in rate, especially at higher current densities is high. This demonstrates the poor Li storage properties of C-LFP electrode at high cycling rates. However, when decreasing the charge/discharge rate to 0.1 C, it is found that the discharge capacity can recover back to 96 mAh/g and then 143 mAh/g and the Coulombic efficiency is also improved.

In case of commercial C-LFMP an initial charge capacity of 121 mAh/g with 90% Coulombic efficiency was achieved which improved to 135 mAh/g in the second charge cycle. Thereafter, a stable capacity of 130 mAh/g, 107 mAh/g, and 40 mAh/g was delivered at 0.2, 0.5 and 1 C, respectively. However, at 2 C and 5 C the delivered capacity is very low. However, after applying such high rates to the electrode, when the rate was again decreased to 0.1 C the C-LFMP cathode recovers and delivers a high charge capacity of 114 mAh/g and then 140 mAh/g and stays almost unchanged thereafter. This observation demonstrates that although the C-LFMP does not function well at high rates, the structure is highly stable and it can recover well after application of high current densities.

Electrochemical Performance of Physically Mixed Commercial C-LFP and C-LFMP and in House C-LFMP Fabricated Using Solid State Method

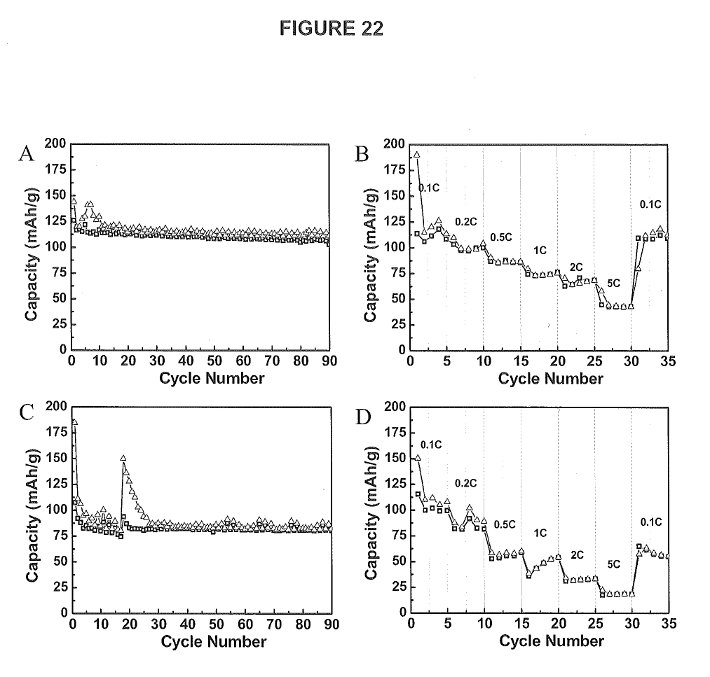

FIG. 22A illustrates the cycling graph of mixed commercial C—LiFePO₄ and in-house fabricated C—LiFe_{0.3}Mn_{0.7}PO₄ electrodes; optimized and produced by ball milling process. The initial cycle results in a charge capacity of 144 mAh/g and a subsequent discharge capacity of 126 mAh/g, this gives an initial Coulombic efficiency of 87%. In the second cycle, the charge capacity decreases to 120 mAh/g with a corresponding discharge capacity of 117 mAh/g, leading to a higher Coulombic efficiency of 97%. After the third cycle the charge capacity increases and Coulombic efficiency is unusually low. After ten cycles the delivered capacity stabilizes and Coulombic efficiency increases to over 92%. It can be observed that the electrode exhibits good cycling stability and delivers charge capacity of 112 mAh/g in the 90th cycle with 93% Coulombic efficiency.

The rate capability of the mixed electrode is also promising (see FIG. 22B), superior to pure commercial olivine products. The electrode was examined at current densities from 0.1 to 5 C. The 1^{st}-cycle charge capacities are 190 mAh/g, 110 mAh/g, 91 mAh/g, 79 mAh/g, 70 mAh/g, and 58 mAh/g at 0.1 C, 0.2 C, 0.5 C, 1 C, 2 C and 5 C, respectively. Additionally, when the charge/discharge rate is decreased to 0.1 C, it is found that the discharge capacity can recover back to 80 mAh/g and then 112 mAh/g, with high Coulombic efficiency. This result can be considered promising both in terms of cyclability and rate capability. Especially since the stability is maintained for 90 cycles and the delivered capacity is moderate at a high rate of 5 C. A good performance which was not observed in pure industrial grade C-LFP electrodes. It is highly probable that by optimizing the in-house and industrial olivine product the electrochemical performance can further be improved.

The second electrode was prepared by mixing commercial C—LiFe_{0.33}Mn_{0.67}PO₄ and in-house fabricated C—LiFe_{0.3}Mn_{0.7}PO₄ produced by ball milling process. The first cycle gives a charge capacity of 184 mAh/g and a subsequent discharge capacity of 107 mAh/g, this results gives an initial Coulombic efficiency of 58% (see FIG. 22C). The extra capacity in the initial cycle may be assigned to the solid electrolyte formation (SEI) and electrolyte decomposition. In the second cycle, the charge capacity drops to 111 mAh/g with a corresponding discharge capacity of 92 mAh/g, leading to a relatively high Coulombic efficiency of 83%. It can be observed that the capacity continues to drop gradually in the initial 17 cycles. Thereafter the charge capacity suddenly rises resulting in low Coulombic efficiency. The reason for such behavior is still under investigation. But, it can be presumed that it is a result of combining two different olivine products. After about 27 cycles the capacity stabilizes and the cycling stability is good thereafter, delivering a discharge and charge capacity of 82 and 81 mAh/g, respectively, with Coulombic efficiency of 98% at the 90th cycle. The rate capability of the mixed C-LFMP electrode was further examined at 0.1 to 0.5 C (see FIG. 22D). The 1^{st}-cycle charge capacities are 150 mAh/g, 87 mAh/g, 58 mAh/g, 39 mAh/g, 34 mAh/g, and 22 mAh/g at 0.1 C, 0.2 C, 0.5 C, 1 C, 2 C, and 5 C rates, respectively. The performance of mixed C-LFMP electrode at each rate is stable and capacity drop with increase in rate is small. Such behavior is highly desirable. However, when decreasing the charge/discharge rate to 0.1 C, it is found that the charge capacity cannot be recovered to the initial quantity and charge capacity of 57 mAh/g is delivered. By comparing the cycling performance and rate capability of two mixed electrodes it can be concluded that mixed commercial and in-house C-LFMP demonstrate interesting and promising properties.

### CONCLUSION

Fabrication of lithium iron manganese phosphate was performed using different fabrication processes such as hydrothermal, solid-state and co-precipitation. The electrochemical investigation of each fabricated product was performed. It was observed that solid state delivers the best electrochemical performance. In an attempt to elevate electrochemical performance of olivine cathodes, C—LiFe_{0.3}Mn_{0.7}PO₄ powder fabricated by solid state method were physically mixed with industrial grade C—LiFePO₄ and C—LiFe_{0.33}Mn_{0.67}PO₄. Battery performance of both set of mixed cathodes was studied in details and based on cycling performance and rate capability of two mixed electrodes, it can be concluded that mixed industrial grade olivine and in-house C-LFMP deliver superior performance compared to their individual constituents.

By “comprising” it is meant including, but not limited to, whatever follows the word “comprising”. Thus, use of the term “comprising” indicates that the listed elements are required or mandatory, but that other elements are optional and may or may not be present.

By “consisting of” is meant including, and limited to, whatever follows the phrase “consisting of”. Thus, the phrase “consisting of” indicates that the listed elements are required or mandatory, and that no other elements may be present.

The inventions illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

By “about” in relation to a given numerical value, such as for temperature and period of time, it is meant to include numerical values within 10% of the specified value.

The invention has been described broadly and generically herein. Each of the narrower species and sub-generic groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non-limiting examples. In addition, where features or aspects of the invention are described in terms of Markush groups, those skilled in the art will recognize that the invention is also thereby described in terms of any individual member or subgroup of members of the Markush group.

1. A cathode material, comprising:
a first olivine structured nanocomposite having a formula of LiFePO₄ or LiFe_{y}Mn_{1-y}PO₄, wherein 0.2≦y≦0.4; and
a second olivine structured nanocomposite having a formula of LiFeₓMn₁₋ₓPO₄, wherein 0.2≦x≦0.4.

2. The cathode material of claim 1, wherein the second olivine structured nanocomposite is present in 5% to 95% based on the total weight of the first olivine structured nanocomposite and the second olivine nanocomposite.

3. The cathode material of claim 2, wherein the second olivine structured nanocomposite is present in 40% based on the total weight of the first olivine structured nanocomposite and the second olivine nanocomposite.

4. The cathode material of claim 1, wherein x and y are different.

5. The cathode material of claim 1, wherein x is 0.3.

6. The cathode material of claim 1, wherein y is 0.33.

7. The cathode material of claim 1, wherein at least one of the first olivine structured nanocomposite and the second olivine structured nanocomposite is coated with carbon.

8. A method for forming a cathode, comprising:
grinding to powder form a first olivine structured nanocomposite having a formula of LiFePO₄ or LiFe_{y}Mn_{1-y}PO₄, wherein 0.2≦y≦0.4;
grinding to powder form a second olivine structured nanocomposite having a formula of LiFeₓMn₁₋ₓPO₄, wherein 0.2≦x≦0.4;
dispersing the first olivine structured nanocomposite powder and the second olivine structured nanocomposite powder in N-methyl-2-pyrrolidone (NMP);
stirring the dispersion to form a slurry;
coating the slurry on a conductive foil; and
drying the coating to form the cathode.

9. The method of claim 8, wherein the dispersing further comprises adding a carbon source to the mixture of the first olivine structured nanocomposite powder and the second olivine structured nanocomposite powder.

10. The method of claim 9, wherein the dispersing further comprising adding polyvinylidene fluoride to the mixture of the first olivine structured nanocomposite powder, the second olivine structured nanocomposite powder, and the carbon source.

11. A lithium rechargeable battery comprising a cathode material, wherein the cathode material comprises:
a first olivine structured nanocomposite having a formula of LiFePO₄ or LiFe_{y}Mn_{1-y}PO₄, wherein 0.2≦y≦0.4; and
a second olivine structured nanocomposite having a formula of LiFeₓMn₁₋ₓPO₄, wherein 0.2≦x≦0.4.

12-17. (canceled)
